(19) United States
(12) Patent Application Publication
(10) Pub. No.: US 2023/0207789 A1
(43) Pub. Date: Jun. 29, 2023

(54) SECONDARY ELECTROCHEMICAL LITHIUM-ION CELL

(71) Applicant: VARTA Microbattery GmbH, Ellwangen Jagst (DE)

(72) Inventors: Edward PYTLIK, Ellwangen (DE); David ENSLING, Ellwangen (DE); Ihor CHUMAK, Ellwangen (DE)

(21) Appl. No.: 17/919,754

(22) PCT Filed: Apr. 28, 2021
(86) PCT No.: PCT/EP2021/061152

§ 371 Date: Oct. 19, 2022

(30) Foreign Application Priority Data
Apr. 29, 2020 (EP) 20172155.2

(51) Int. Cl. H01M 4/38; H01M 10/0525; H01M 4/134; H01M 50/107; H01M 50/109; H01M 50/538; H01M 4/04; H01M 10/0587

(52) U.S. Cl. CPC H01M 4/382; H01M 10/0525; H01M 4/134; H01M 50/107; H01M 50/109; H01M 50/538; H01M 4/0404; H01M 4/0445; H01M 10/0587; H01M 2004/027

(57) ABSTRACT

A lithium-ion secondary electrochemical cell includes a negative electrode formed as a composite electrode comprising an anode current collector and a first electrochemically active component capable of intercalating and deintercalating lithium ions. The lithium-ion electrochemical cell further includes a positive electrode formed as a composite electrode comprising a cathode current collector and a second electrochemically active component capable of intercalating and deintercalating lithium ions. The lithium-ion electrochemical cell also includes a lithium reserve formed at a current collector reserve region that is at least partly free of the first and the second electrochemically active components, the current collector reserve region being a portion of the anode current collector and/or the cathode current collector.

### CROSS REFERENCE TO RELATED APPLICATIONS

This application is a U.S. National Phase application under 35 U.S.C. § 371 of International Application No. PCT/EP2021/061152, filed on Apr. 28, 2021, and claims benefit to European Patent Application No. EP 20172155.2, filed on Apr. 29, 2020. The International Application was published in German on Nov. 4, 2021 as WO 2021/219732 under PCT Article 21(2).

### FIELD

The present disclosure relates to a lithium-ion secondary electrochemical cell, to a coil or stack for a lithium-ion secondary electrochemical cell that is formed from negative and positive electrodes, to a process for producing such a coil or stack, and to a process for producing a lithium-ion secondary electrochemical cell.

### BACKGROUND

Electrochemical cells are able to convert stored chemical energy into electrical energy through a redox reaction. The electrochemical cells generally comprise a positive and a negative electrode. During a discharge, electrons are released at the negative electrode as a result of an oxidation process. This results in an electron current that can be drawn off by an external consumer, the electrochemical cell thus acting as a supplier of energy. At the same time, an ion current corresponding to the electrode reaction occurs within the cell. This ion current is made possible by an ion-conducting electrolyte.

If the discharge is reversible, the cell is said to be a secondary cell, which means that there is the possibility of reversing the conversion of chemical energy into electrical energy that took place during the discharge, and thus of charging the cell. The designation of the negative electrode as the anode and of the positive electrode as the cathode, which is customary in secondary cells, refers to the discharge function of the electrochemical cell.

The widely used lithium-ion cells are based on the use of lithium, which is able to migrate back and forth in ionic form between the electrodes of the cell. A feature of lithium-ion cells is a comparatively high energy density. The negative electrode and the positive electrode of a lithium-ion cell are usually formed from what are known as composite electrodes, which, in addition to electrochemically active components, also comprise electrochemically inactive components.

Suitable as electrochemically active components (active materials) are in principle all materials that are able to absorb and release lithium ions. Particles based on carbon, for example graphitic carbon, are often used here for the negative electrode. Other non-graphitic carbon materials suitable for lithium intercalation may also be used. In addition, it is also possible to use metallic and semimetallic materials that can be alloyed with lithium. For example, the elements tin, antimony, and silicon are able to form intermetallic phases with lithium. Examples of active materials that can be used for the positive electrode include lithium cobalt oxide (LiCoO₂), lithium manganese oxide (LiMn₂O₄) or lithium iron phosphate (LiFePO₄) or derivatives thereof. The electrochemically active materials are usually present in the electrodes in particle form.

As electrochemically inactive components, the composite electrodes generally comprise a planar and/or tape-like current collector, for example a metallic foil, that is coated with the active material. The current collector for the negative electrode (anode current collector) can be formed for example from copper or nickel and the current collector for the positive electrode (cathode current collector) can be formed for example from aluminum. In addition, the electrodes may comprise an electrode binder (for example polyvinylidene fluoride (PVDF) or another polymer). This ensures the mechanical stability of the electrodes and often also the adhesion of the active material to the current collectors. In addition, the electrodes may comprise conductivity-improving additives and other additions.

Common electrolyte solutions for lithium-ion cells are, for example, solutions of lithium salts such as lithium hexafluorophosphate (LiPF₆) in organic solvents (for example ethers and esters of carbonic acid).

In the production of a lithium-ion cell, the composite electrodes are often processed into a stack or a coil in which the negative electrode(s) and the positive electrode(s) are separated from one another within the stack or coil by means of a separator.

For electrical contacting of the negative and positive electrodes, current conductors can be provided, which are connected to the current collectors, for example by welding. Direct contacting of the current collectors with a housing element of the lithium-ion cell is also an option.

The function of a lithium-ion cell is based on there being sufficient mobile lithium ions (mobile lithium) available to compensate, through migration between the anode and the cathode (i.e. the negative electrode and the positive electrode), the electrical current that is drawn off. In the context of this application, mobile lithium is to be understood as meaning that the lithium is available for intercalation and deintercalation processes in the electrodes during the discharging and charging processes in the lithium-ion cell, or can be activated for this purpose. In the course of the discharging and charging processes that take place in a lithium-ion cell, losses of mobile lithium occur over time. These losses occur as a result of various side reactions that are generally unavoidable. Losses of mobile lithium occur even during the very first charge/discharge cycle of a lithium-ion cell. During this first charge/discharge cycle, a surface layer usually forms on the surface of the electrochemically active components on the negative electrode. This surface layer is referred to as solid electrolyte interphase (SEI) and usually consists primarily of electrolyte decomposition products and also a certain amount of lithium, which is firmly bound in this layer. The loss of mobile lithium associated with this process can range from 10% to 35%. The losses in the subsequent charge/discharge cycles are significantly lower. However, the ongoing loss of mobile lithium does over time lead to a progressive decrease in capacity and performance in conventional lithium-ion cells.

Various approaches are already known for compensating the loss of mobile lithium that occurs. For example, EP 2 486 620 B1 describes a lithium-ion cell having improved aging behavior, in which the capacity of the negative electrode for taking up lithium is oversized in relation to the positive electrode and at the same time in relation to the totality of mobile lithium. At the same time, there is present in the cell an amount of mobile lithium that exceeds the capacity of the positive electrode for taking up lithium.

EP 3 255 714 A1 discloses an electrochemical cell having a lithium depot, the lithium depot being provided in the cell in the form of a lithium alloy. The lithium depot may be arranged for example between the electrodes and the housing of the cell.

EP 2 372 732 A1 describes a spirally wound coil having negative and positive electrodes for an electrochemical lithium-ion cell, wherein present within the coil is a lithium-ion source that is separated from the positive electrode and the negative electrode by means of a separator in such a way that it does not come into contact with the electrodes.

### SUMMARY

In an embodiment, the present disclosure provides a lithium-ion secondary electrochemical cell. The lithium-ion electrochemical cell includes a negative electrode formed as a composite electrode comprising an anode current collector and a first electrochemically active component capable of intercalating and deintercalating lithium ions. The lithium-ion electrochemical cell further includes a positive electrode formed as a composite electrode comprising a cathode current collector and a second electrochemically active component capable of intercalating and deintercalating lithium ions. The lithium-ion electrochemical cell also includes a lithium reserve formed at a current collector reserve region that is at least partly free of the first and the second electrochemically active components, the current collector reserve region being a portion of the anode current collector and/or the cathode current collector.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic top view of a negative electrode and of a positive electrode according to a preferred embodiment;

FIG. 2 shows a schematic cross-sectional view of a negative electrode and a positive electrode according to the preferred embodiment depicted in FIG. 1;

FIG. 3 shows a schematic representation of an electrode arrangement arranged in a housing in the form of a coil (cross section) according to a preferred embodiment;

FIG. 4 shows a top view of a current collector in a configuration with openings;

FIG. 5 shows a cross-sectional view of the current collector depicted in FIG. 4;

FIG. 6 shows a top view of a negative electrode that can be processed into a lithium-ion cell;

FIG. 7 shows a cross-sectional view of the negative electrode depicted in FIG. 6;

FIG. 8 shows a top view of a composite unit produced using the negative electrode depicted in FIG. 7, a positive electrode, and two separators; and

FIG. 9 shows a cross-sectional view of the composite unit made up of the electrodes and the separators depicted in FIG. 8.

### DETAILED DESCRIPTION

The present disclosure provides an improved lithium-ion cell in which losses of mobile lithium can be compensated in a particularly advantageous manner. This improved lithium-ion cell should prevent or slow down cell aging processes in order to achieve a particularly long cell service life.

The present disclosure provides a lithium-ion secondary electrochemical cell and a coil or stack for a lithium-ion secondary electrochemical cell. In addition, the present disclosure provides a process for producing a coil or stack of this kind and a process for producing an electrochemical lithium-ion cell.

According to a first aspect of the present disclosure, a lithium-ion cell is characterized by the following features:
a. It comprises at least one composite electrode as a negative electrode, the composite electrode comprising at least one anode current collector and at least one electrochemically active component capable of intercalating and deintercalating lithium ions.
b. It comprises at least one composite electrode as a positive electrode, the composite electrode comprising at least one cathode current collector and at least one electrochemically active component capable of intercalating and deintercalating lithium ions.

It is characterized in particular by the following feature:
c. the negative electrode and/or the positive electrode has/have at least one region in which the anode current collector and/or the cathode current collector is at least partly free of the electrochemically active component, this region being formed as a lithium reserve.

The negative electrode and/or the positive electrode thus comprise a current collector having at least one region that is covered by an electrochemically active component and at least one other region that is free of this component and is formed as a lithium reserve.

The region formed as a lithium reserve is preferably completely free of the electrochemically active component.

The region is preferably also free of the electrode binder mentioned and/or of the conductivity-improving additives mentioned.

What is meant by a lithium reserve in this context is that this region of the negative electrode and/or of the positive electrode has a charge of metallic lithium and/or of a lithium-containing material. Over the course of the service life of the lithium-ion cell of the invention, the lithium stored in this region serves as a depot for lithium, which can be released as mobile lithium in ionic form and be available for the charge/discharge cycles of the lithium-ion cell after its release. This can significantly improve the service life of the lithium-ion cell, since aging processes that are based on a loss of mobile lithium can be compensated by the lithium reserve.

In all cases, the metallic lithium or lithium-containing material of the lithium reserve differs materially from the electrochemically active component, which usually likewise comprises lithium, possibly in ionic form (see below). The lithium depot thus preferably does not comprise any lithium-containing alloy or compound that is a constituent of the electrochemically active component.

The arrangement of the lithium reserve directly on the current collectors, that is to say to a certain extent within the negative electrode and/or the positive electrode, has particular advantages, especially with regard to the optimal utilization of the geometry of the lithium-ion cell. By arranging the lithium reserve directly on a region of the current collector that is free of electrochemically active component, it is possible to make optimal use of the space within the lithium-ion cell without the lithium reserve taking up additional space within the lithium-ion cell. The region for the lithium reserve can be chosen so that there are no geometric clashes with other elements of the lithium-ion cell. For instance, the arrangement of the lithium depot described in EP 2 372 732 A1 can increase the risk of electrical short circuiting caused by the lithium depot coming into contact with edges of oppositely polarized electrodes. The formation of the lithium depot can take place already during production of the electrodes. This means that no separate steps for the forming and placement of the depot are required at a later stage.

The anode current collector and cathode current collector of the negative and positive electrode(s) respectively are preferably planar metal substrates, made for example from metal foils or from a metal foam or from a metal net or a metal mesh or a metallized nonwoven. Suitable metals for the anode current collector are for example copper or nickel or another electrically conductive material. A suitable metal for the cathode current collector is for example aluminum or another electrically conductive material.

As electrochemically active components for the negative electrode and the positive electrode, it is possible to use materials known to those skilled in the art. Particularly suitable for use as the negative electrode are carbon-based particles such as graphitic carbon or non-graphitic carbon materials that are capable of intercalating lithium, preferably likewise in particle form. As an alternative or in addition, metallic and semimetallic materials that can be alloyed with lithium may also be used, for example using the elements tin, antimony, and silicon, which are capable of forming intermetallic phases with lithium. These materials too are preferably used in particle form. For the positive electrode, it is possible to use as electrochemically active components for example lithium-metal oxide compounds and lithium-metal phosphate compounds such as LiCoO₂ and LiFePO₄. Also highly suitable are especially lithium nickel manganese cobalt oxides (NMC) having the molecular formula LiNiₓMn_{y}Co_{z}O₂ (where x+y+z is typically 1), lithium manganese spinel (LMO) having the molecular formula LiMn₂O₄, or lithium nickel cobalt aluminum oxide (NCA) having the empirical formula LiNiₓCo_{y}Al_{z}O₂ (where x+y+z is typically 1). It is also possible to use derivatives thereof, for example lithium nickel manganese cobalt aluminum oxides (NMCA) having the empirical formula Li_{1.11}(Ni_{0.40}Mn_{0.39}Co_{0.16}Al_{0.05})_{0.89}O₂ or Li₁₊ₓM-O compounds and/or mixtures of the materials mentioned.

The particulate electrochemically active components are preferably embedded in a matrix of the mentioned electrode binder, in which neighboring particles in the matrix are preferably in direct contact with one another.

It is particularly preferable when structured current collectors are used as anode current collector and/or as cathode current collector, for example metal foils that are perforated or otherwise provided with openings, or metal nets or metal meshes or metallic or metallized nonwovens or open-pored metal foams. This has the particular advantage that the lithium ions later released from the lithium reserve migrate particularly readily throughout the lithium-ion cell and can be uniformly distributed over the entire lithium-ion cell.

For optimized distribution of lithium ions in the cell, the cell of the invention particularly preferably comprises as anode current collector, a tape-like metal foil having a thickness within a range from 4 μm to 30 μm and having a first and a second longitudinal edge and two end pieces and as cathode current collector, a tape-like metal foil having a thickness within a range from 4 μm to 30 μm and having a first and a second longitudinal edge and two end pieces, wherein the anode current collector has a tape-like main region that is laden with a layer of negative electrode material, and also a free edge strip that extends along the first longitudinal edge and is not laden with the electrode material and/or the cathode current collector has a tape-like main region that is laden with a layer of positive electrode material, and also a free edge strip that extends along the first longitudinal edge and is not laden with the electrode material.

It is preferable that both the anode current collector and the cathode current collector have the tape-like main region and the free edge strip.

The tape-like main region of the anode current collector and/or the tape-like main region of the cathode current collector, particularly preferably the tape-like main region of the anode current collector and the tape-like main region of the cathode current collector, preferably have a large number of openings.

The large number of openings results in a reduced volume and also reduced weight in the current collector(s). This makes it possible to introduce more active material into the cell and in this way to sharply increase the energy density of the cell. Increases in energy density as high as the double-digit percentage range can be achieved in this way.

In particularly preferred configurations, the cell of the invention is characterized by having at least one of the additional features a. and b. immediately below:
a. The openings in the main region are round or square holes, in particular punched or drilled holes.
b. The main region of the anode current collector and/or of the cathode current collector is perforated, in particular by round-hole perforation or slotted-hole perforation.

In some preferred embodiments, the openings are introduced into the tape-like main region by means of a laser.

The geometry of the openings is not in principle an essential feature of the invention. What is important is that the introduction of the openings results in the mass of the current collector being reduced and in there being more space therein for active material, since the openings can be filled with the active material.

On the other hand, it can be very advantageous when introducing the openings to ensure that the maximum diameter of the openings is not too large. The openings should preferably be not more than twice the thickness of the layer of the electrode material on the respective current collector.

In particularly preferred configurations, the cell of the invention is characterized by having the additional feature a. immediately below:
a. The openings in the current collector, particularly in the main region, have diameters within a range from 1 μm to 3000 μm.

Within this preferred range, further preference is given to diameters within a range from 10 μm to 2000 μm, preferably from 10 μm to 1000 μm, especially from 50 μm to 250 μm.

It is particularly preferable when the cell of the invention is characterized by having at least one of the additional features a. and b. immediately below:
a. In at least a portion of the main region, the anode current collector and/or the cathode current collector have a lower weight per unit area than in the associated free edge strip.
b. In the free edge strip, the anode current collector and/or the cathode current collector have no perforations or have fewer perforations per unit area than in the main region.

It is particularly preferable when features a. and b. immediately above are realized in combination with one other.

The free edge strips of the anode current collector and cathode current collector delimit the main region on the side of the first longitudinal edges. Preferably, the anode current collector and cathode current collector each include free edge strips along both longitudinal edges.

The openings characterize the main region. In other words, the border between the main region and the free edge strip(s) corresponds to a transition between regions having and not having openings.

The openings are preferably distributed essentially uniformly over the main region(s).

In further particularly preferred embodiments, the cell of the invention is characterized by having at least one of the features a. to c. immediately below:
a. The weight per unit area of the anode current collector and/or of the cathode current collector is in the main region reduced by 5% to 80% compared to the weight per unit area of the respective current collector in the free edge strip.
b. In the main region, the current collector has a perforated area within a range from 5% to 80%.
c. In the main region, the current collector has a tensile strength of from 20 N/mm² to 250 N/mm²

The perforated area, which is commonly referred to also as the free cross section, can be determined in accordance with ISO 7806-1983. The tensile strength of the current collector(s) in the main region is reduced compared to current collectors without openings. It can be determined in accordance with DIN EN ISO 527 Part 3.

It is preferable that the anode current collector and the cathode current collector are of identical or similar design in respect of the openings. The improvements in energy density that are in each case achievable are additive.

In addition to the components already mentioned, the lithium-ion secondary electrochemical cell of the invention expediently also comprises a housing that preferably encloses the electrodes in a gas-tight and/or liquid-tight manner.

In some preferred configurations, the cell comprises an electrical conductor for electrical contacting of the negative electrode and/or an electrical conductor for electrical contacting of the positive electrode, so as to permit electrical contacting of the electrodes. One end of these electrical conductors may be welded to the anode current collector or to the cathode current collector. Another end may be welded to a housing element or be passed out of the housing through a terminal bushing.

In other embodiments, direct contacting of the electrodes with the housing or with parts of the housing may also be present. This is particularly preferable and will be dealt with separately.

In addition, the lithium-ion cell expediently comprises at least one separator for separating the positive and negative electrodes in a manner known per se.

In addition, the cell comprises at least one electrolyte that is customary per se, especially one based on at least one lithium salt, for example lithium hexafluorophosphate, which is present dissolved in an organic solvent (for example in a mixture of organic carbonates). For the configuration of the lithium-ion cell of the invention, it is particularly advantageous when the region comprising the lithium reserve is in ionic contact with the electrolyte, so that the lithium ions released from the lithium reserve are directly available for the electrochemical processes in the cell.

The integration of a lithium reserve into an electrode coil or an electrode stack allows the cycle life of the lithium-ion cell to be prolonged and, particularly preferably, the energy density to be increased too. The reason for this is because an aging process that limits the service life of lithium-ion cells is generally caused by the loss of mobile lithium. By introducing a lithium reserve onto uncoated regions (i.e. regions that are not coated with electrochemically active components) of the negative electrode and/or of the positive electrode, preferably of the negative electrode only, this lithium reserve, or a corresponding prelithiation of these regions, is able to serve as a reservoir for mobile lithium over the cycle life of the lithium-ion cell.

Moreover, particularly in the case of silicon-containing negative electrodes, the energy density can be increased too and thus costs reduced, since the lithium-ion cell of the invention generally requires less cathode material, which normally serves as the lithium source. The negative electrode is therefore particularly preferably a silicon-containing electrode or a composite electrode that is coated with a silicon-containing electrochemically active material.

In a preferred further development, the lithium-ion cell of the invention is characterized by having at least one of the features a. to c. immediately below:
a. The negative electrode formed as a composite electrode and the positive electrode formed as a composite electrode are each in tape form.
b. The negative electrode and the positive electrode are separated from one another by a separator.
c. The negative electrode and the positive electrode are constituents of a coil.

It is particularly preferable when features a. to c. immediately above are realized in combination with one other.

In this particularly preferred configuration, the negative electrode and the positive electrode together with the separator form a composite unit that is processed into a coil, especially a spiral coil. Such a coil is preferably cylindrical in design and has two terminal, preferably flat, end faces. Providing the electrodes in the form of such a coil permits a particularly advantageous arrangement of the electrodes in cylindrical housings.

In a preferred further development, the lithium-ion cell of the invention is characterized by having at least one of the features a. and b. immediately below:
a. The region is located at a longitudinal end of the tape-like negative electrode and/or of the tape-like positive electrode.
b. The region comprising the lithium reserve forms an outer side of the coil and/or delimits a void in the center of the coil.

It is particularly preferable when features a. and b. immediately above are realized in combination with one other.

The outer side of the coil may be formed for example by the negative electrode. The region comprising the lithium reserve may occupy part of this outer side or the entire outer side of the coil. The region of the lithium reserve is here preferably applied only on the outer side of the anode current collector and not on the inner side of the anode current collector, so that the inner side of the electrode of the outer coiling is coated with the electrochemically active component in the usual manner.

As an alternative or in addition, the region comprising the lithium reserve may be located in the core of the coil. These particular locations for the region of the lithium reserve are especially advantageous, since these regions are generally unused and consequently the use of these regions for a lithium reserve is particularly advantageous and economical.

In an alternative preferred further development, the lithium-ion cell of the invention is characterized by having at least one of the features a. to c. immediately below:
a. The negative electrode formed as a composite electrode and the positive electrode formed as a composite electrode are part of a stack in which they are arranged one on top of the other.
b. The negative electrode and the positive electrode are separated from one another by a separator.
c. The region formed as the lithium reserve is located at one edge of the tape-like negative electrode and/or of the tape-like positive electrode.

It is particularly preferable when features a. to c. immediately above are realized in combination with one other.

This form of arrangement of negative electrode(s) and positive electrode(s) can likewise be used to advantage for different geometries of a lithium-ion cell, it being possible with this arrangement of the electrodes to produce in particular lithium-ion cells having prismatic housings.

In a preferred further development, the lithium-ion cell of the invention is characterized by having at least one of the features a. orb. immediately below:
a. the anode current collector and the cathode current collector each have two flat sides separated by a peripheral edge and are each coated on both sides with the electrochemically active components,
b. the region formed as a lithium reserve is located on only one flat side of the anode current collector and/or of the cathode current collector.

It is particularly preferable when features a. and b. immediately above are realized in combination with one other.

In particularly preferred configurations of the lithium-ion cell of the invention, both the anode current collector and the cathode current collector have the two flat sides, which are in each case coated with the respective electrochemically active components. The region comprising the lithium reserve is preferably located on only one of the flat sides of the anode current collector and/or of the cathode current collector.

In a preferred further development, the lithium-ion cell of the invention is characterized by having at least one of the features a. orb. immediately below:
a. the lithium-ion cell comprises a housing that encloses the negative electrode and the positive electrode,
b. the region of the negative electrode or of the positive electrode formed as a lithium reserve faces toward the housing of the lithium-ion cell.

It is particularly preferable when features a. and b. immediately above are realized in combination with one other.

This configuration is particularly advantageous, since these regions of the electrode generally do not contribute to the electrochemical processes in the lithium-ion cell and can therefore be used to particular advantage for the lithium reserve. In this embodiment, it is accordingly especially the edge regions of the electrode arrangement that are used for introducing a coating with lithium-containing material here in place of a coating with the electrochemically active components.

In a very particularly preferred configuration, only the negative electrode is used for the formation of the lithium reserve. In this embodiment, only the negative electrode has the at least one region in which the anode current collector is at least partly free of the electrochemically active component and wherein this region is formed as a lithium reserve.

In a preferred further development, the lithium-ion cell of the invention is characterized by having at least one of the features a. to h. immediately below:
a. the lithium reserve comprises electrochemically active lithium that is arranged in the region on the anode current collector and/or cathode current collector that is formed as a lithium reserve.
b. the lithium reserve comprises activatable lithium that is arranged in the region on the anode current collector and/or cathode current collector that is formed as a lithium reserve.
c. the lithium reserve comprises at least one lithium-containing compound, especially a lithium-containing alloy, that is arranged in the region on the anode current collector and/or cathode current collector that is formed as a lithium reserve.
d. the lithium reserve is formed from a lithium foil that is arranged in the region on the anode current collector and/or cathode current collector that is formed as a lithium reserve.
e. the lithium reserve is formed from a lithium strip that is arranged in the region on the anode current collector and/or cathode current collector that is formed as a lithium reserve.
f. the lithium reserve is formed from vapor-deposited lithium or lithium-containing material that is arranged in the region on the anode current collector and/or cathode current collector that is formed as a lithium reserve.
g. the lithium reserve is formed from encapsulated lithium particles that are arranged in the region on the anode current collector and/or cathode current collector that is formed as a lithium reserve.
h. the lithium reserve is formed from a coating that is arranged in the region on the anode current collector and/or cathode current collector that is formed as a lithium reserve.

The lithium or lithium-containing materials may be applied onto the corresponding region of the positive electrode and/or especially of the negative electrode, for example in the form of a paste or other coating. For example, encapsulated lithium particles such as SLMP (stabilized lithium metal powder, FMC Corporation, USA) may be used for this purpose.

Lithium in metallic form may for example be electrochemically deposited, vapor-deposited or pressed on.

The lithium reserve is particularly preferably activatable by cycling.

The energy storage element of the invention may be a button cell. Button cells are cylindrical and have a height that is less than their diameter. They are suitable for supplying electrical energy to small electronic devices such as watches, hearing aids, and wireless headphones.

The energy storage element of the invention is preferably a cylindrical button cell having a circular upper side that is flat in at least a central part-area, a circular lower side that is flat in at least a central part-area, and an annular casing disposed in between. The shortest distance between a point on the flat area or part-area on the top side and a point on the area or part-area on the bottom side is preferably within a range from 4 mm to 15 mm. The maximum distance between two points on the casing of the button cell is preferably within a range from 5 mm to 25 mm. The proviso here is that the maximum distance between the two points on the casing side is greater than the distance between the two points on the top side and bottom side.

The nominal capacity of the energy storage element of the invention formed as a button cell is in one embodiment as a lithium-ion cell generally up to 1500 mAh. The nominal capacity is preferably within a range from 100 mAh to 1000 mAh, more preferably within a range from 100 to 800 mAh.

The energy storage element of the invention may also be a cylindrical round cell. Cylindrical round cells have a height that is greater than their diameter. They are suitable for supplying modern metering applications, security applications, and automotive applications such as electricity meters, water meters, and gas meters, heating cost meters, medical pipettes, sensors and alarm systems, home alarm systems, sensors and sensor networks, backup batteries for anti-theft systems in automotive engineering with electrical energy.

The height of the round cells is preferably within a range from 15 mm to 150 mm. The diameter of the cylindrical round cells is preferably within a range from 10 mm to 50 mm. Within these ranges, shape factors of, for example, 18×65 (diameter x height in mm) or 21×70 (diameter x height in mm) are particularly preferred. Cylindrical round cells having these shape factors are particularly suitable for powering electric drives in motor vehicles and tools.

The nominal capacity of the energy storage element of the invention formed as a cylindrical round cell is in one embodiment as a lithium-ion cell generally up to 6000 mAh. With the shape factor of 21×70, the cell in one embodiment as a lithium-ion cell preferably has a nominal capacity within a range from 2000 mAh to 5000 mAh, more preferably within a range from 3000 to 4500 mAh.

In the European Union, manufacturer information on the nominal capacities of secondary batteries is strictly regulated. For instance, information on the nominal capacity of secondary nickel-cadmium batteries is based on measurements in accordance with standards IEC/EN 61951-1 and IEC/EN 60622, information on the nominal capacity of secondary nickel-metal hydride batteries on measurements in accordance with standard IEC/EN 61951-2, information on the nominal capacity of lithium secondary batteries on measurements in accordance with standard IEC/EN 61960, and information on the nominal capacity of lead-acid secondary batteries on measurements in accordance with standard IEC/EN 61056-1. Any information on nominal capacities in the present application is preferably also based on these standards. In a particularly preferred configuration, the lithium-ion cell of the invention is configured such that the electrodes are formed in the shape of a coil according to what is known as a contact-plate design, as described in particular in WO 2017/215900 A1. Reference is hereby made to WO 2017/215900 A1 in its entirety.

In particularly preferred embodiments, the lithium-ion cell of the invention has the characteristic feature that within the composite unit of electrodes and separator present in the form of a coil, the positive and negative electrodes are arranged offset to one another such that a longitudinal edge of the anode current collector emerges from one of the terminal end faces and a longitudinal edge of the cathode current collector emerges from the other terminal end face, the lithium-ion cell of the invention has a metallic contact plate that rests on one of the longitudinal edges, resulting in a linear contact zone, and the contact plate is connected to the longitudinal edge along this linear contact zone by welding.

When producing composite units made up of electrodes and separators, care is usually taken to ensure that current collectors of opposite polarity do not protrude on the same side, since this can increase the risk of short circuiting. However, in the described offset arrangement the risk of short circuiting is minimized, since the current collectors of opposite polarity emerge from opposite end faces of the coil or stack.

The protrusion of the current collectors resulting from the offset arrangement can be exploited by them being contacted preferably over their entire length by a corresponding current conductor. The contact plate mentioned is used here as a current conductor. This can very significantly reduce the internal resistance within the cell of the invention. The arrangement described is thus able to absorb the occurrence of large currents very well. With minimized internal resistance, thermal losses at high currents are reduced. In addition, the dissipation of thermal energy via the poles is favored.

The contact plate can in turn be connected to a pole of the cell of the invention, for example to a pole in the housing.

There are several ways in which the contact plate can be connected to the longitudinal edge.

The contact plate can be connected to the longitudinal edge along the linear contact zone via at least one weld seam. The longitudinal edge can according to the invention comprise one or more sections, each of which is over its entire length continuously connected to the contact plate via a weld seam.

In a possible further development, the section(s) continuously connected to the contact plate over its/their entire length can extend over at least 25%, preferably over at least 50%, more preferably over at least 75%, of the total length of the longitudinal edge.

Very particularly preferably, the longitudinal edge may be continuously welded to the contact plate over its entire length.

In some preferred embodiments, the cell of the invention has at least one of the following features. The contact plate is a metal plate having a thickness within a range from 200 μm to 1000 μm, preferably 400-500 μm. The contact plate is made of aluminum, titanium, nickel, stainless steel or nickel-plated steel.

The contact plate may have at least one slot and/or at least one perforation. These serve to counteract deformation of the plate during production of the welded joint.

In preferred embodiments, the contact plate is in the shape of a disk, in particular the shape of a circular or at least approximately circular disk. It then thus has an outer, circular or at least approximately circular disk edge. An approximately circular disk is to be understood here as meaning in particular a disk that has the shape of a circle having at least one separated circle segment, preferably having two to four separated circle segments.

Particularly preferably, the cell of the invention has a first contact plate that rests on the longitudinal edge of the anode current collector, such that a linear first contact zone having spiral geometry results, and a second contact plate that rests on the longitudinal edge of the cathode current collector, such that a linear second contact zone having spiral geometry results. Preferably, both contact plates are connected to a pole of the cell of the invention, for example to a pole in the housing.

In particularly preferred embodiments, the first contact plate and the anode current collector are both made of the same material. This is particularly preferably selected from the group comprising copper, nickel, titanium, nickel-plated steel, and stainless steel.

The second contact plate and the cathode current collector are particularly preferably both made of the same material from the group comprising aluminum, titanium, and stainless steel (for example type 1.4404).

The invention further comprises a coil or stack for a lithium-ion secondary electrochemical cell. The coil or stack has the following features:
a. The coil or stack comprises at least one composite electrode as the negative electrode, the composite electrode comprising at least one anode current collector and at least one electrochemically active component capable of intercalating and deintercalating lithium ions.
b. The coil or stack comprises at least one composite electrode as the positive electrode, the composite electrode comprising at least one cathode current collector and at least one electrochemically active component capable of intercalating and deintercalating lithium ions.
c. The negative electrode and the positive electrode are separated from one another by a separator,
d. the negative electrode and/or the positive electrode have at least one region in which the anode current collector and/or the cathode current collector is at least partly free of the electrochemically active component, this region being formed as a lithium reserve.

As regards further features of this coil or of this stack and especially with regard to the forming of the lithium reserve, reference is made to the above description.

In addition, the invention includes a process for producing the described coil or described stack that is provided for a lithium-ion secondary electrochemical cell. This process comprises the following steps:
a. Providing a composite electrode as a negative electrode, by coating a tape-like and/or planar anode current collector on both sides with at least one electrochemically active component capable of intercalating and deintercalating lithium ions.
b. Providing a composite electrode as a positive electrode, by coating a tape-like and/or planar cathode current collector on both sides with at least one electrochemically active component capable of intercalating and deintercalating lithium ions.
c. Omitting, during the coating of the anode current collector and/or of the cathode current collector with the electrochemically active component, of at least one region, which is not coated with the respective electrochemical component.
d. Charging the at least one omitted region with a lithium-containing material so as to form a lithium reserve.
e. Processing the negative and the positive electrode with at least one separator to form a coil or a stack.

As regards further features of this production process and especially with regard to the electrodes and the region for the lithium reserve, reference is made to the above description.

Finally, the invention includes a process for producing an electrochemical lithium-ion cell in the manner described above. This process comprises the following steps:
a. Providing a coil or stack as described above.
b. Placing the coil or stack in a housing.
c. Providing the coil or stack with at least one electrolyte.
d. Electrically contacting the negative electrode and the positive electrode with the housing or with electrical conductors that can be routed through the housing.
e. Closing the housing.

The housing is in particular a housing that is customary for such cells, for example a housing for a cylindrical round cell or a button cell. In addition, the process preferably comprises an electrical contacting of the negative and of the positive electrodes. In some preferred embodiments, the electrical contacting is effected with the aid of separate electrical conductors. However, it is also possible for direct contacting with the housing to be effected via the contact plates, especially in the case of the contact plate design described above.

Further features and advantages of the invention will be apparent from the following description of working examples in conjunction with the drawings. The individual features may here each be realized individually or in combination with one other.

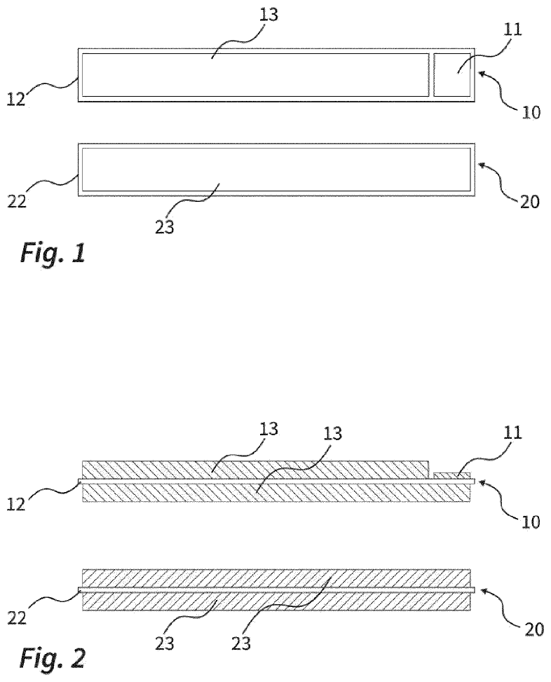

FIG. 1 and FIG. 2 illustrate schematically a negative electrode 10 and a positive electrode 20 in top view (FIG. 1) and in cross section (FIG. 2). In this working example, the negative electrode 10, which is designed in the form of a tape, has a region 11 at one end that is designed as a lithium reserve. Both the negative electrode 10 and the positive electrode 20 are formed as composite electrodes, wherein an anode current collector 12 in the case of the negative electrode 10 and a cathode current collector 22 in the case of the positive electrode 20 are on both sides coated with an electrochemically active component 13 and 23 respectively. The electrochemically active component 13 of the negative electrode 10 may for example be a mixture of silicon and graphite and an electrode binder. The electrochemically active component 23 of the positive electrode 20 is for example a particulate lithium metal oxide compound in a binder matrix.

In the negative electrode 10, the region 11 formed as a lithium reserve is located at one end of the tape-like electrode on one side of the anode current collector 12. The lithium-containing material present in region 11 may for example be a lithium foil or a lithium strip. In other working examples, this can take the form here of vapor-deposited lithium or lithium substances in a paste or other coating. For example, the lithium-containing material can be formed from encapsulated lithium particles that are applied onto the anode current collector 12 in the form of a coating.

The anode current collector 12 and the cathode current collector 22 may take the form of customary electrically conductive foils, especially metallic foils or foil tapes. For the negative electrode, copper or nickel are particularly suitable for this purpose. For the positive electrode, aluminum is particularly suitable for this purpose. The anode current collector and cathode current collector are preferably present in structured form, for example perforated or as an open-pore foam.

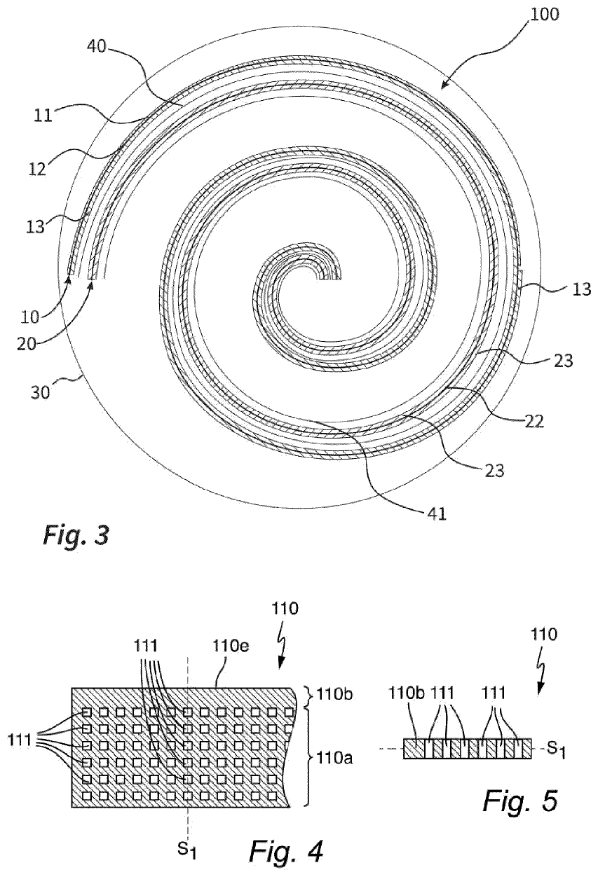

FIG. 3 illustrates schematically the structure of a coil 100 formed from the electrodes 10 and 20. The coil 100 has a spiral structure, wherein a composite unit made up of negative electrode 10 and positive electrode 20, which are separated from one another by a separator 40, is formed by coiling around a coil axis. For clarity, the electrodes 10 and 20 and the separator 40 are drawn spaced apart. In reality, they lie directly on top of one other and are connected to one another for example by lamination. The outer coil is formed on the outside by the negative electrode 10, the outer side of the negative electrode 10 partly comprising a region 11 that is formed as a lithium reserve. In this region, the negative electrode 10 is not coated with an electrochemically active component, but is instead charged with a lithium material. The outer region of the negative electrode 10 does not face toward the positive electrode 20, but toward the inside of the housing 30.

FIG. 4 and FIG. 5 exemplify the design of a perforated current collector 110 that can be used in a cell of the invention. FIG. 4 is a section along S1. The current collector 110 includes a large number of openings 111, which are rectangular holes. Region 110a is characterized by the openings 111, whereas in region 110b there are no openings along the longitudinal edge 110e. The current collector 110 accordingly has a significantly lower weight per unit area in region 110a than in region 110b.

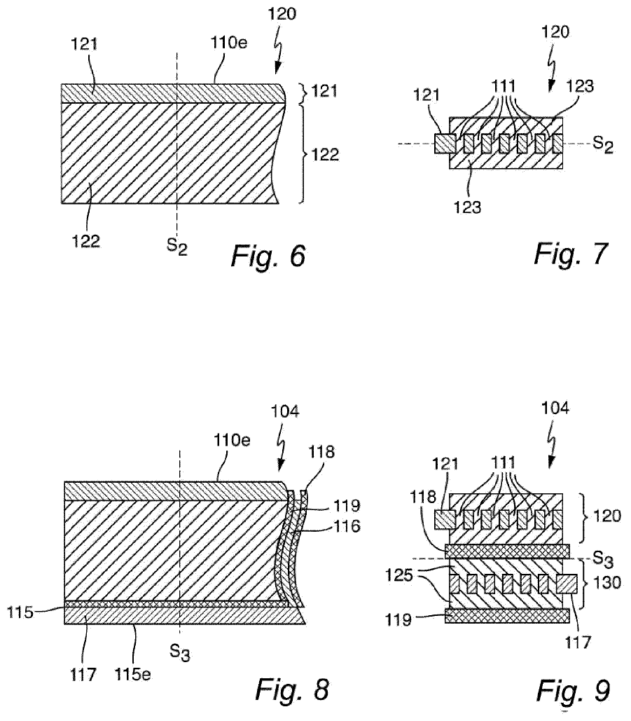

FIG. 6 and FIG. 7 exemplify a negative electrode 120 produced by applying a negative electrode material 123 to both sides of the current collector 110 depicted in FIG. 4 and FIG. 5. FIG. 7 is a section along S2. The current collector 110 now has a tape-like main region 122 that is laden with a layer of the negative electrode material 123, and also a free edge strip 121 that extends along the longitudinal edge 110e and is not laden with the electrode material 123. The electrode material 123 additionally fills the openings 111.

FIG. 8 and FIG. 9 exemplify an electrode-separator composite unit 104 produced using the negative electrode 120 depicted in FIG. 6 and FIG. 7. In addition, it comprises the positive electrode 130 and the separators 118 and 119. FIG. 9 is a section along S3. The positive electrode 130 is constructed according to the same current collector design as the negative electrode 120. The current collectors 110 and 115 of the negative electrode 120 and of the positive electrode 130 preferably differ only in the respective choice of material. Thus, the current collector 115 of the positive electrode 130 has a tape-like main region 116 that is laden with a layer of positive electrode material 125, and also a free edge strip 117 that extends along the longitudinal edge 115e and is not laden with the electrode material 125. Through spiral winding it is possible to transform the composite unit 104 into a coil, as may be present in a cell of the invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A lithium-ion secondary electrochemical cell, comprising:
a negative electrode formed as a composite electrode comprising an anode current collector and a first electrochemically active component capable of intercalating and deintercalating lithium ions;
a positive electrode formed as a composite electrode comprising a cathode current collector and a second electrochemically active component capable of intercalating and deintercalating lithium ions; and
a lithium reserve formed at a current collector reserve region that is at least partly free of the first and the second electrochemically active components, the current collector reserve region being a portion of the anode current collector and/or the cathode current collector.

2: The lithium-ion electrochemical cell as claimed in claim 1, further comprising a separator that separates the negative electrode from the positive electrode,
wherein the negative electrode is formed as a negative electrode tape and the positive electrode is formed as a positive electrode tape, and
wherein the negative electrode and the positive electrode are constituents of a coil.

3: The lithium-ion electrochemical cell as claimed in claim 2,
wherein the current collector reserve region is located at a longitudinal end of the negative electrode tape and/or of the positive electrode tape, and
wherein the current collector reserve region forms an outer side of the coil and/or delimits a void in a center of the coil.

4: The lithium-ion electrochemical cell as claimed in claim 1, further comprising a separator that separates the negative electrode from the positive electrode,
wherein the negative electrode and the positive electrode are part of a stack in which they are arranged one on top of the other, and
wherein the current collector reserve region is located at an edge of a tape-like negative electrode and/or of a tape-like positive electrode.

5: The lithium-ion electrochemical cell as claimed in claim 1,
wherein the anode current collector and the cathode current collector each has two flat sides separated by a peripheral edge and is coated on both sides with the first or the second electrochemically active components, and
wherein the current collector reserve region formed is located on only one flat side of the anode current collector and/or of the cathode current collector.

6: The lithium-ion electrochemical cell as claimed in claim 1, further comprising
a housing that encloses the negative electrode and the positive electrode,
wherein at least a portion of the current collector reserve region faces toward the housing of the lithium-ion electrochemical cell.

7: The lithium-ion electrochemical cell as claimed in claim 1, wherein
the current collector reserve region is located only on the anode current collector.

8: The lithium-ion electrochemical cell as claimed in claim 1, wherein the lithium reserve has at least one of the following characteristics:
the lithium reserve comprises electrochemically active lithium arranged in the current collector reserve region,
the lithium reserve comprises activatable lithium arranged in the current collector reserve region,
the lithium reserve comprises at least one lithium-containing compound arranged in the current collector reserve region,
the lithium reserve is formed from a lithium foil that is arranged in the region on the anode current collector and/or cathode current collector,
the lithium reserve is formed from a lithium strip arranged in the current collector reserve region,
the lithium reserve is formed from vapor-deposited lithium or lithium-containing material arranged in the current collector reserve region,
the lithium reserve is formed from encapsulated lithium particles arranged in the current collector reserve region,
the lithium reserve is formed from a coating arranged in the current collector reserve region.

9: The lithium-ion electrochemical cell as claimed in claim 1, wherein
the lithium reserve is activatable by cycling.

10: The lithium-ion electrochemical cell as claimed in claim 1, wherein
the lithium-ion cell is a cylindrical round cell or
a button cell.

11: The lithium-ion electrochemical cell as claimed in claim 1, wherein
the negative electrode and the positive electrode are components of a coil or of a stack,
wherein the negative electrode and the positive electrode are arranged offset within the coil or the stack, such that a longitudinal edge of the anode current collector emerges from one terminal end face of the coil or stack and a longitudinal edge of the cathode current collector emerges from another terminal end face of the coil or stack,
wherein a longitudinal edge of the anode current collector and/or a longitudinal edge of the cathode current collector are/is configured to contact part of a housing of the lithium-ion electrochemical cell.

12: A coil or stack for a lithium-ion secondary electrochemical cell, the coil or stack comprising:
a negative electrode formed as a composite electrode comprising an anode current collector and a first electrochemically active component capable of intercalating and deintercalating lithium ions;
a positive electrode formed as a composite electrode comprising a cathode current collector and a second electrochemically active component capable of intercalating and deintercalating lithium ions;
a separator that separates the negative electrode and the positive electrode from one another; and
a lithium reserve formed at a current collector reserve region that is at least partly free of the first and the second electrochemically active components, the current collector reserve region being a portion of the anode current collector and/or the cathode current collector.

13: The coil or stack as claimed in claim 12, wherein the negative electrode is formed as a negative electrode tape,
wherein the positive electrode is formed as a positive electrode tape, and
wherein one of:
the negative electrode and the positive electrode are constituents of a coil, the current collector reserve region is located at a longitudinal end of the negative electrode tape and/or of the positive electrode tape and the current collector reserve region forms an outer side of a coil and/or delimits a void in a center of a coil, or
the negative electrode and the positive electrode are part of a stack in which they are arranged one on top of the other and the current collector reserve region is located at an edge of the negative electrode tape and/or an edge of the positive electrode tape.

14: A process for producing the coil or stack, as claimed in claim 12, for a lithium-ion secondary electrochemical cell, the process comprising:
providing the negative electrode by coating the anode current collector, which has a tape-like and/or planar configuration, on both sides with the first electrochemically active component,
providing the positive electrode by coating the cathode current collector, which has a tape-like and/or planar configuration, on both sides with the second electrochemically active component capable of intercalating and deintercalating lithium ions,
omitting, during the coating of the anode current collector with the first electrochemically active component and/or of the cathode current collector with the second electrochemically active component, the current collector reserve region such that the current collector reserve region is not coated with the first electrochemically active component or with the second electrochemically active component,
charging the current collector region with a lithium-containing material so as to form the lithium reserve, and
processing the negative electrode and the positive electrode with at least one separator to form the coil or stack.

15: The process as claimed in claim 14, further comprising:
placing the coil or stack in a housing,
providing the coil or stack with an electrolyte,
electrically contacting the negative electrode and the positive electrode with the housing or with electrical conductors configured to be routed through the housing, and
closing the housing.

16: The lithium-ion electrochemical cell as claimed in claim 1, wherein the current collector reserve region includes both a portion of the anode current collector that is not coated with the first electrochemically active component and a portion of the cathode current collector that is not coated with the second electrochemically active component.

17: The lithium-ion electrochemical cell as claimed in claim 1, wherein the negative electrode is formed as a composite electrode comprising the anode current collector and multiple electrochemically active components capable of intercalating and deintercalating lithium ions, and/or
wherein the positive electrode is formed as a composite electrode comprising the cathode current collector and multiple electrochemically active components capable of intercalating and deintercalating lithium ions.

18: The lithium-ion electrochemical cell as claimed in claim 1, wherein the negative electrode is formed as a composite electrode comprising multiple anode current collectors, and/or
wherein the positive electrode is formed as a composite electrode comprising multiple cathode current collectors.
